(19) United States
(12) Patent Application Publication
(10) Pub. No.: US 2016/0249109 A1
(43) Pub. Date: Aug. 25, 2016

(54) SYSTEM AND METHOD FOR THE DETECTION OF ADVERTISEMENTS IN TELEVISION AND OTHER VIDEO PROGRAMMING

(71) Applicant: ZACHERY NELSON, Chester Springs, PA (US)

(72) Inventor: ZACHERY NELSON, Chester Springs, PA (US)

(73) Assignee: SKIPR.TV, LLC, Chester Springs, PA (US)

(21) Appl. No.: 14/631,537

(22) Filed: Feb. 25, 2015

(51) Int. Cl. H04N 21/488; H04N 21/41; H04N 21/475; H04N 21/433; H04N 21/458; H04N 21/482; H04N 21/25; H04N 21/81; H04N 21/472

(52) U.S. Cl. CPC H04N 21/4882; H04N 21/812; H04N 21/4126; H04N 21/4758; H04N 21/47217; H04N 21/458; H04N 21/8173; H04N 21/4821; H04N 21/4586; H04N 21/251; H04N 21/4334

(57) ABSTRACT

A method for detecting a commercial advertisement in a video program includes estimating a timing of the commercial based on historical timing of the commercial within the program. The program is displayed on a first display device. An alert is displayed on a client voting mechanism associated with the first display device when the estimated timing of the commercial indicates that a beginning of the commercial is imminent. An indication that the commercial has begun is receiving from the viewer of the first display device using the client voting mechanism. The indication of the beginning of the commercial is sent from the client voting mechanism to a client viewing mechanism associated with a second display device. A display of the second display device is switched from the program to an alternative task when the indication of the beginning of the commercial is received.

### TECHNICAL FIELD

The present disclosure relates to detection of advertisements and, more specifically, to systems and methods for the detection of advertisements in television and other video programming.

### DISCUSSION OF THE RELATED ART

Television programming generally includes content with commercial advertisements interspersed therein. While television viewers may be keenly interested in the programming content, the commercial advertisements are generally of less interest to the viewers. Moreover, modern viewers may be less interested in providing their undivided attention to watching television programming and may tend to engage in other forms of tasks while watching the television programming. For example, modern viewers may be inclined to communicate via social media or engage in other forms of new media while watching television.

While these viewers may choose to employ tablet computers and smartphones for engaging in these other tasks, today, television programming may be consumed on devices such as personal computers, tablet computers, and smartphones while the introduction of smart televisions and various set-top-boxes has opened the door for viewers to engage in tasks previously performed on personal computers, tablet computers, and smartphones on their television sets.

Accordingly, during the airing of the commercial advertisements, television viewers may explore programming on other channels, utilize smart-TV or set-top-box features, or pick up a portable electronic device such as a smart phone, tablet computer or personal computer and engage in various other tasks until their program content is restored. However, this approach suffers from the drawbacks of viewers worrying about or actually switching back to their program content late.

### SUMMARY

A method for detecting a commercial advertisement in a video program includes estimating a timing of a commercial advertisement within the video program based on historical timing of a plurality of previous commercial advertisements within the video program. The video program is displayed on a first display device. A first alert is displayed on a client voting mechanism associated with the first display device when the estimated timing of the commercial advertisement indicates that a beginning of the commercial advertisement is imminent. An indication that the commercial advertisement has begun is receiving, from the viewer of the first display device using the client voting mechanism. The indication of the beginning of the commercial advertisement is sent from the client voting mechanism to a client viewing mechanism associated with a second display device. A display of the second display device is switched from the video program to an alternative task when the indication of the beginning of the commercial advertisement is received.

The method may further include displaying a second alert on the client voting mechanism when the estimated timing of the commercial advertisement indicates that an ending of the commercial advertisement is imminent, receiving, from the viewer of the first display device, an indication that the commercial advertisement has ended, using the client voting mechanism, sending the indication of the ending of the commercial advertisement from the client voting mechanism to the client viewing mechanism, and switching the display of the second display device from the alternative task to the video programming when the indication of the ending of the commercial advertisement is received.

The first alert on the client voting mechanism may be a countdown alert beginning at a fixed time before the estimated beginning of the commercial advertisement and ending at the estimated beginning of the commercial advertisement.

The sending of the indication of the beginning of the commercial advertisement from the client voting mechanism to the client viewing mechanism may be performed over the Internet, with a computational server acting as an intermediary to the sending.

There may be a plurality of client voting mechanisms and the alert may be sent from the computational server to the client viewing mechanism based on a plurality of alerts received by the plurality of client voting mechanisms.

The alternative task may be an execution of a computer application.

Switching the display of the second display device may include changing the display of the second display device from exclusively displaying the video program to exclusively displaying the alternative task.

Switching the display of the second display device may include changing from a first display configuration in which the second display device displays the video program with a primary focus while the second display device simultaneously displays the alternative task with a secondary focus to a second display configuration in which the second display device displays the alternative task with the primary focus while the second display device simultaneously displays the video program with the secondary focus.

A padding value, representing a length of a delay in the displaying of the video program on the second display device, may be stored by the client viewing mechanism. The switching of the display of the second display device from the video program to the alternative task may be delayed by the padding value after the indication of the beginning of the commercial advertisement is received.

The padding value may be set according to a video program service provider of the second display device and a viewer of the second display device may modify the padding value as desired.

A system for detecting a commercial advertisement in a video program includes a computational server configured to retrieve historical timing of a plurality of previous commercial advertisements within the video program from a historical database and to estimate a timing of the commercial advertisement within the video program based on the retrieved historical timing. A first display device is configured to display the video program. A client voting mechanism, associated with the first display device, is configured to display an alert when the estimated timing of the commercial advertisement indicates that a beginning of the commercial advertisement is imminent, to receive, from a viewer of the first display device, an indication that the commercial advertisement has begun, and transmit the indication of the beginning of the commercial advertisement to a client viewing mechanism associated with a second display device. The client viewing mechanism is configured to switch a display of the second display device from the video program to an alternative task when the indication of the beginning of the commercial advertisement is received.

The client viewing mechanism may include a set-top-box for providing the alternative task to the second display device.

The client voting mechanism may include a hand held unit for receiving, from the viewer of the first display device, the indication of the beginning of the commercial advertisement.

A method for playing a recorded video program includes estimating a timing of a commercial advertisement within a video program based on historical timing of the commercial advertisement within the video program. The video program is recorded using a digital video recorder (DVR) and is simultaneously displayed on a first display device. A first alert is displayed on a client voting mechanism associated with the first display device, when the estimated timing of the commercial advertisement indicates that a beginning of the commercial advertisement is imminent. An indication that the commercial advertisement has begun is received, from the viewer of the first display device, using the client voting mechanism. An indication that the commercial advertisement has ended is received from the viewer of the first display device, using the client voting mechanism. The recorded video program is played using the DVR from a start of the recorded program to a point corresponding to a time when the indication of the beginning of the commercial advertisement was received. A number of advances needed to skip the playing of the commercial advertisement is calculated based on the point corresponding to a time when the indication of the beginning of the commercial advertisement was received and a point corresponding to a time when the indication of the ending of the commercial advertisement was received. The playing of the recorded video program is advanced by the calculated number of advances. The playing of the recorded video program is continued.

The first alert on the client voting mechanism may be a countdown alert beginning at a fixed time before the estimated beginning of the commercial advertisement and ending at the estimated beginning of the commercial advertisement.

The receiving of the indication of the beginning of the commercial advertisement by the DVR may be performed over the Internet, with a computational server acting as an intermediary to the receiving.

There may be a plurality of client voting mechanisms and the alert may be sent from the computational server to the DVR based on a plurality of alerts received by the plurality of client voting mechanisms.

### BRIEF DESCRIPTION OF THE DRAWINGS

A more complete appreciation of the present disclosure and many of the attendant aspects thereof will be readily obtained as the same becomes better understood by reference to the following detailed description when considered in connection with the accompanying drawings, wherein:

FIG. 1 is a flow chart illustrating an overview approach for the switching of viewer activities based on commercial advertisement detection in accordance with exemplary embodiments of the present invention;

FIG. 2 is a flow chart illustrating an operation of the Computational Server in detecting the commercial advertisements of the video programming in accordance with exemplary embodiments of the present invention;

FIG. 3 is a flow chart illustrating an operation of the Client Voting Mechanism in detecting the commercial advertisements of the video programming in accordance with exemplary embodiments of the present invention;

FIG. 4 is a flow chart illustrating an operation of the Client Viewing Mechanism in detecting the commercial advertisements of the video programming in accordance with exemplary embodiments of the present invention;

FIG. 5 is a flow chart illustrating an operation of a Client Viewing Mechanism in detecting the commercial advertisements of the video programming and applying the detection to the skipping of commercials in a prerecorded television program in accordance with exemplary embodiments of the present invention;

FIG. 6 is a schematic diagram illustrating an arrangement of a system for detecting commercial advertisements in television programming in accordance with exemplary embodiments of the present invention;

FIG. 7 is a schematic diagram illustrating a Client Voting/Viewing Mechanism for detecting commercials in television programming in accordance with exemplary embodiments of the present invention; and

FIG. 8 shows an example of a computer system capable of implementing the method and apparatus according to embodiments of the present disclosure.

### DETAILED DESCRIPTION OF THE DRAWINGS

In describing exemplary embodiments of the present disclosure illustrated in the drawings, specific terminology is employed for sake of clarity. However, the present disclosure is not intended to be limited to the specific terminology so selected, and it is to be understood that each specific element includes all technical equivalents which operate in a similar manner.

As television programming is increasingly likely to share a screen with other tasks, viewers may be interested in employing hardware and methods for helping them to divide their attention between television programming and the other tasks. Because viewers tend to be least engaged in television programming during the airing of the commercial advertisements, exemplary embodiments of the present invention provide hardware and methods to assist them in effectively utilizing the period of time within which the commercial advertisement is being aired to engage in the other activities while returning the viewer's focus to the television programming content upon the completion of the commercial advertisements.

In particular, exemplary embodiments of the present invention provide systems and methods for the detection of commercial advertisements within video programming. While this detection of commercial advertisements within video programming may be used for the purposes of providing alternative activities, tasks, and diversions to the viewer, exemplary embodiments of the present invention are not limited to this use. For example, commercial advertisement detection, as herein described, may be applied to the skipping of commercial advertisements in recorded programming, or various other applications. Moreover, detection, as herein described, may be applied not only to commercial advertisements, but also to other forms of content which viewers may have a reason to not want to see, such as age-inappropriate content, etc.

It should be understood that while this video programming may include television programming such as programming typically aired by broadcast and cable television networks, video programming, as used herein, may also include Internet-based programming, for example, streaming video, or other new media programming. Moreover, the concepts described herein, while described in terms of video programming, may be expanded to include commercial advertisement detection in audio programming such as radio broadcasts (whether it be delivered over-the-air, via satellite or Internet-based streaming).

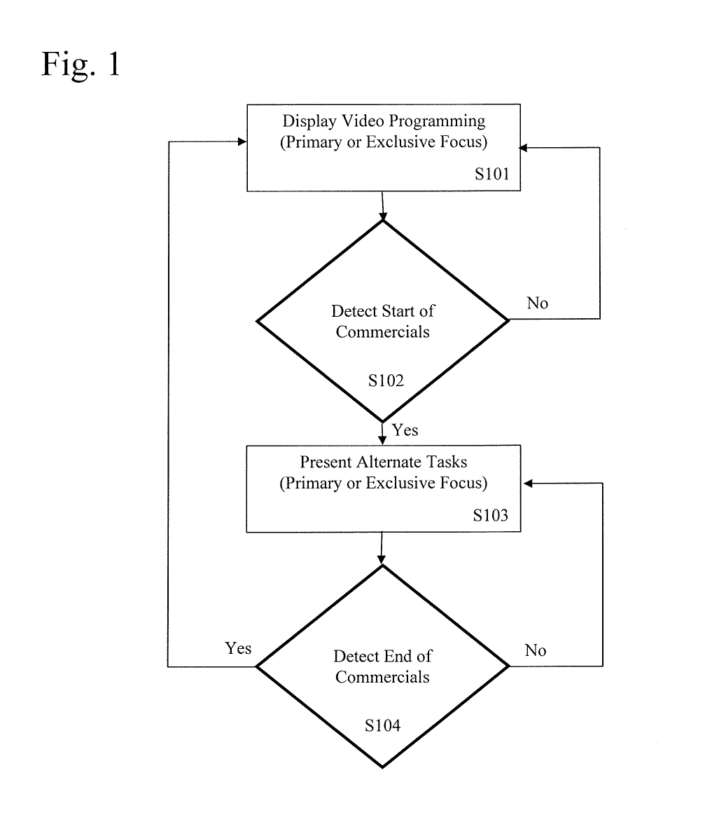

FIG. 1 is a flow chart illustrating an overview approach for the switching of viewer activities based on commercial advertisement detection in accordance with exemplary embodiments of the present invention. On the onset, video programming may be displayed for the viewer's consumption (Step S101). The video programming may be provided to a display device, which may be a television set, a computer monitor, a laptop computer, a tablet computer, a smartphone, or the like. The video programming may be provided to the display device though a television tuner, a cable box, a set-top-box, a computer, a video game console, or the like. The video content may be displayed either exclusively, which is to say, no other content is provided simultaneously, or the video content may share the display with alternative content but have a primary focus on the display device.

For as long as the start of a commercial advertisement is not detected (No, Step S102), the video content may continue to be viewed with primary or exclusive focus. However, upon the detection of the start of a commercial advertisement (Yes, Step S102), an alternative task may be presented (Step S103). The alternative task, as described above, may be any other display besides that of the video programming. For example, the alternative task may be a website, a computer application, a video game, a display of valuable information such as sports scores, stock prices, news headline, etc., a photograph or a slideshow of photographs, or even other video content.

Presentation of the alternative task may utilize the entirety of the display device (exclusive presentation) or the alternative task may utilize a portion of the display device. For example, the video programming may continue to be displayed in a portion of the display device as a picture-in-picture window or as a split screen display.

Presentation of the alternative task may be performed either automatically or manually. Where presentation of the alternative task is automatic, a set-top-box, or other device implementing the presently described approach, may control which input signal is sent to the display device, for example, by receiving a first HDMI cable carrying the television content, a second HDMI cable carrying the alternative task and selecting which signal to pass through to a third HDMI cable which is directly connected to the display device. Alternatively, the set-top-box may originate the alternative task and the HDMI cable carrying the television content and selectively pass the signals to the display device.

Alternatively, a Smart TV may be used to implement the approach described herein. According to such an approach, the Smart TV may receive the television content signal and may receive or originate the alternative task and may be responsible for performing the switching of the primary/exclusive display. Other possibilities are contemplated and fall within the scope of the present invention.

Where presentation of the alternative task is manually performed, the viewer may receive an indicia of the eminent start of the commercial advertisement and the viewer may have the option to act on this information by changing the display from the video programming to the alternative task.

Regardless of the means of display change, the present approach may continue to provide the alternative content to the viewer until the end of the commercials is detected (Yes, Step S104). At that point the primary/exclusive focus of the display device may be returned to the video programming. Until that point (No, Step S104), the display of the alternative content may continue.

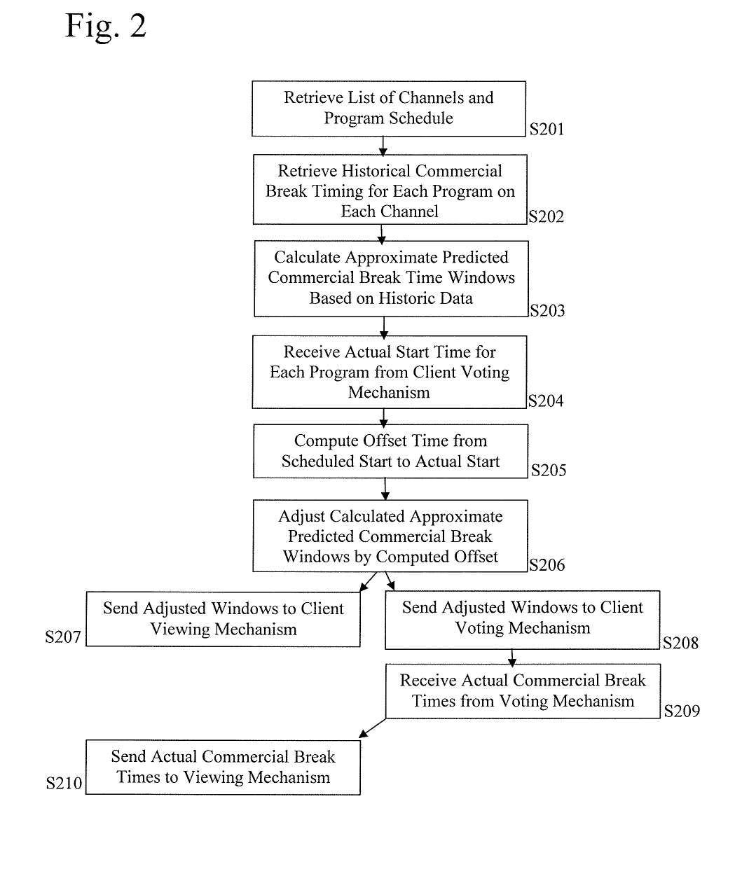

Many of the details for implementing the above-described approach will be described below. Exemplary embodiments of the present invention may utilize a client/server model for implementing the approaches described herein. While the client device may include the display device and the set-top-box, as previously discussed, the server system may be referred to herein as a Computational Server, even though the server system may be embodied as a plurality of distributed servers or one or more virtual machines hosted on one or more physical computer systems. FIG. 2 is a flow chart illustrating an operation of the Computational Server in detecting the commercial advertisements of the video programming in accordance with exemplary embodiments of the present invention.

First, the Computational Server may receive a list of available networks and scheduled programming (Step S201). The list of available networks may be a list of television channels available to one or more viewers who utilize the presently described approach. These viewers may be referred to herein as “subscribers.” The scheduled programming may be received for each available network. This information may be obtained via a proprietary database service that curates television program scheduling information.

The Computational Server may retrieve this information, for example, either by downloading a master file from the database service or by generating specific queries to the database service and receiving responses to these queries.

The Computational Server may maintain a database of historical commercial break begin and end times for each program on each television channel. The manner in which this database is constructed will be described in greater detail below, however, according to the approach described herein, the Computational Server may retrieve from this database, the historical commercial break timing for each program on each channel (Step S202).

From this retrieved historical commercial break timing, the Computational Server may calculate a predicted approximate commercial break window. This window is defined as an estimated commercial break start time and an estimated commercial break end time. In a simplest embodiment, the window may be calculated by gathering the time at which a first commercial break begins for each program for each channel and then computing the mean average thereof to arrive at a begin time for a first commercial break for that given program on that given channel. An end time for the first commercial break may be similarly calculated, as well as windows for the second, third, and subsequent commercial breaks.

However, exemplary embodiments of the present invention are not limited to calculating approximate predicted commercial break time windows using simple averaging, other, more sophisticated statistical approaches may be used, such as excluding outlier values, excluding values obtained during programming preemptions, etc. According to one exemplary embodiment of the present invention, the Computational Server may calculate approximate predicted commercial break time windows using one or more machine learning techniques in which the retrieved historical commercial break time windows are used as training data.

The approximate predicted commercial break time windows, once calculated, may be sent to the client systems, for example, as described below. As described herein, there are two types of client systems. The first is the Client Voting Mechanism and the second is the Client Viewing Mechanism. While some exemplary embodiments of the present invention utilize client systems that act as both the Client Voting Mechanism and the Client Viewing Mechanism, for the purpose of providing a simplified explanation, they will be described separately herein. The Client Voting Mechanism is responsible for interacting with human users called “voters” who provide to the Computational Server actual start and end times for commercial breaks. The Client Viewing Mechanism is responsible for interacting with human users called “viewers” who utilize the start and end times for commercial breaks to change primary/exclusive focus between video programming and other tasks as described above.

It is contemplated by the present approach, that television programs do not always start exactly according to schedule and therefore, the Computational Server receives from the Client Voting Mechanisms, an indication of an actual start time for each program on each channel (Step S204). Ideally, there may be a large number of Client Voting Mechanisms providing information for every television program on every channel, however, as the number of Client Voting Mechanisms may be limited, exemplary embodiments of the present invention may limit the scope of the implementation to a subset of channels and/or a subset of shows. Where there are multiple Client Voting Mechanisms reporting on a start time for a single program, this data may be fused to come up with a single actual start time for the program. The fusion may be calculated by a weighted average where Client Voting Mechanisms known to have a good history of successfully providing data are weighted more heavily than Client Voting Mechanisms known to provide inferior data.

The actual start time data may be used to compute an offset for the scheduled program start time (Step S205). This offset may be thought of as a measure of how late the program was in starting. The calculated approximate predicted commercial break windows may then be adjusted by the computed offset (Step S206).

The adjusted calculated approximate predicted commercial break windows may be sent from the Computational Server to the Client Viewing Mechanisms (Step S207). As will be described in detail below, the Client Viewing Mechanisms may use this information to provide the viewers with an indication of when a commercial is likely to begin or end.

The calculated approximate predicted commercial break windows may also be sent from the Computational Server to the Client Voting Mechanisms (Step S208). As will be described in detail below, the Client Voting Mechanisms may use this information to provide the voters with an indication of when a commercial is likely to begin or end.

The Computational Server may then receive from the Client Voting Mechanisms an indicia of when actual commercial breaks begin and end (Step S209). The Computational Server may then use this information to send to the Client Viewing Mechanisms an indication of an actual time at which commercial breaks begin and end (Step S210).

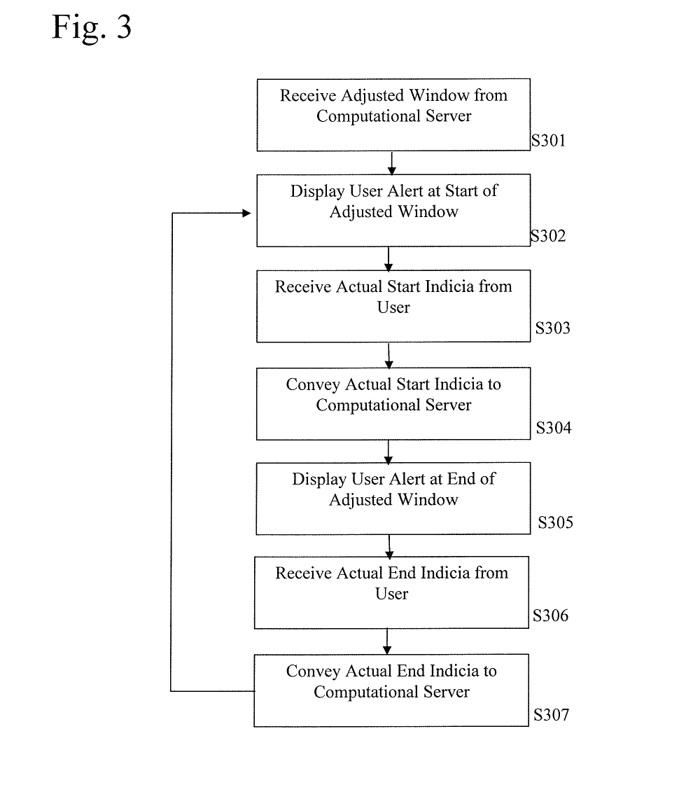

FIG. 3 is a flow chart illustrating an operation of the Client Voting Mechanism in detecting the commercial advertisements of the video programming in accordance with exemplary embodiments of the present invention. As mentioned above with respect to FIG. 2, the Computational Server sends to the Client Voting Mechanisms an adjusted window (Step S208). Thus as step S301, the Client Voting Mechanism receives the adjusted windows. The adjusted windows indicate predicted start and end times for commercial breaks, adjusted for the actual start time of the television program. The Client Voting Mechanism may then use these adjusted windows to display an alert to the voter that a commercial break may soon be starting (Step S302). The alert may be generated some set amount of time prior to the estimated start time of the commercial break to give the voter some time to notice the alert and prepare. This set time may be, for example, 2, 5, 10 or 30 seconds in duration. The alert may be audible and/or visual and may include a countdown clock displayed on the display device responsible for viewing the video programming. Alternatively, or additionally, the alert may be a blinking LED indicator disposed on a remote control device associated with the Client Voting Mechanism or a display icon on a smartphone application associated with the Client Voting Mechanism, as will be discussed in more detail below. The voter may then wait for the actual commercial break to begin and may thereafter use the Client Voting Mechanism to register an indicia of the actual start of the commercial break, for example, by pressing a physical button on the remote control or touching an icon on the smartphone. The Client Voting Mechanism may therefore receive an actual start indicia from the user (Step S303).

The Client Voting Mechanism may then convey this actual start indicia to the Computational Server (S304), for example, over the Internet, as will be described in more detail below.

In a manner very similar to the way in which the commercial break start alert was generated and presented, the Client Voting Mechanism may use the adjusted window to display an alert to the voter that a commercial break may soon be ending (Step S305) and again, the voter may use the Client Voting Mechanism to register an indicia of the actual end of the commercial break. The end indicia may be received by the Client Voting Mechanism (Step S306) and conveyed to the Computational Server (Step S307) and this process may be repeated for all commercial breaks of the television program.

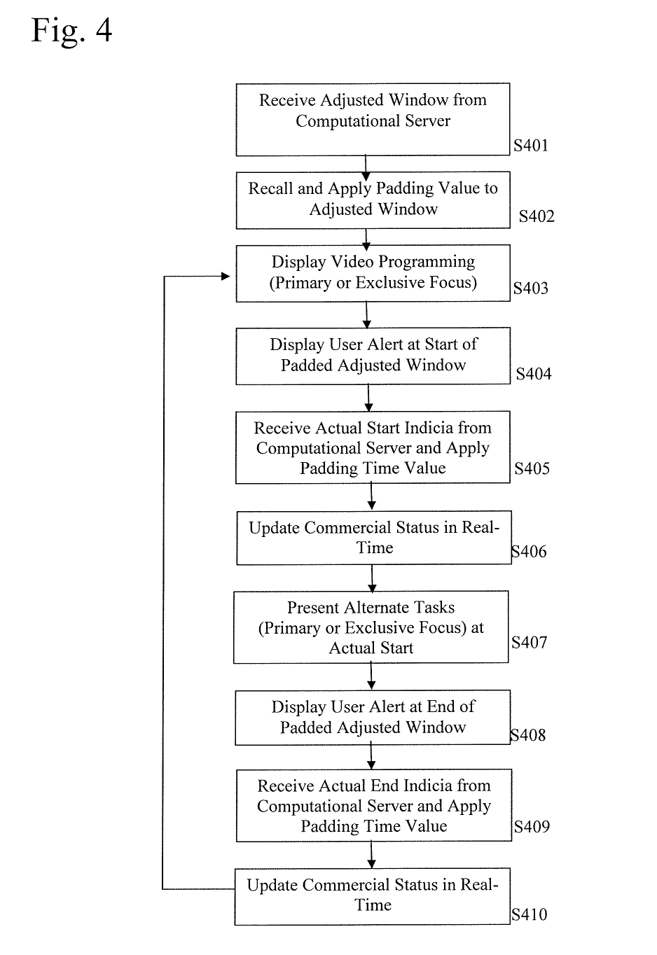

FIG. 4 is a flow chart illustrating an operation of the Client Viewing Mechanism in detecting the commercial advertisements of the video programming in accordance with exemplary embodiments of the present invention. As mentioned above with respect to FIG. 2, the Computational Server sends to the Client Viewing Mechanisms an adjusted window (Step S207). Thus as step S401, the Client Viewing Mechanism receives the adjusted windows. Depending on where each Client Viewing Mechanism is installed, what television service provider is used, and various other factors, the Client Viewing Mechanism may receive the television video signal with a slight delay. Thus each Client Viewing Mechanism may have its own padding value, which is a set length of time that the Client Viewing Mechanism's television video signal is delayed by, relative to the timing of the adjusted window. This padding value may be stored by the Client Viewing Mechanism. The default padding value may be set in accordance with a known padding value for the viewer's television service provider and the viewer may have the option to adjust this value as need be. However, in Step S402, the stored padding value is recalled and applied to the adjusted window.

The video programming may be displayed with primary/exclusive focus, for example, as described in detail above (Step S403). The Client Viewing Mechanism may then display to the viewer an alert indicating an imminent start of a commercial break based on the padded adjusted window (Step S404). The actual start indicia may then be received from the Computational server, and the padding time added thereto (Step S405).

The Client Viewing Mechanism may maintain a commercial break status and this status may begin, for example, in a “program” state. The commercial break status may be updated to “commercial” when the padding time has elapsed from the moment when the start indicia was received to indicate that the television video has gone to commercial break (Step S405).

As discussed above, the realization by the Client Viewing Mechanism that the television video has gone to commercial break may have various consequences ranging from altering the viewer of this status so that the viewer may engage in the alternate task, to automatically changing primary/exclusive focus of the display device to the alternate task (Step S407).

Similarly, a user alert may be displayed as the end of the padded adjusted window approaches (Step S408), an actual indicia of the end of the window may be received and padded (Step S409), and the commercial status may be updated back to “program” (Step S410). The process may continue for each of the commercial breaks.

It is to be understood that while the approach discussed above is described in terms of the Client Viewing Mechanism initially operating to display the video programming and then later switching to display the alternate task when the commercial advertisement begins, it is to be understood that in some cases the viewing may begin during the airing of a commercial advertisement. In such cases, primary/exclusive focus may initially be directed to the alternate task and may later be changed to the video programming upon the ending of the commercial break.

Moreover, exemplary embodiments of the present invention may provide, to the Client Viewing Mechanism, an electronic program guide (EPG) so that the viewer may be able to access this guide to determine what programs are presently being aired on each television network. The EPG may also show what programs are scheduled to be aired in subsequent time slots. The EPG may be provided to the Client Viewing Mechanism by the Computational Server. Additionally, for each program presently being aired, the EPG may provide to the viewer, an indication as to whether that program is presently in commercial break or whether that program is presently airing. This information may be updated, in real-time, by the Computational Server based on the indications provided by the Client Voting Mechanisms. It is to be understood that for each Client Viewing Mechanism receiving this commercial status EPG, the padding value may be applied so that to the extent that the particular Client Viewing Mechanism experiences a delay, that delay is accounted for in the EPG. It is understood that the viewer may use this EPG information to select a television program to watch.

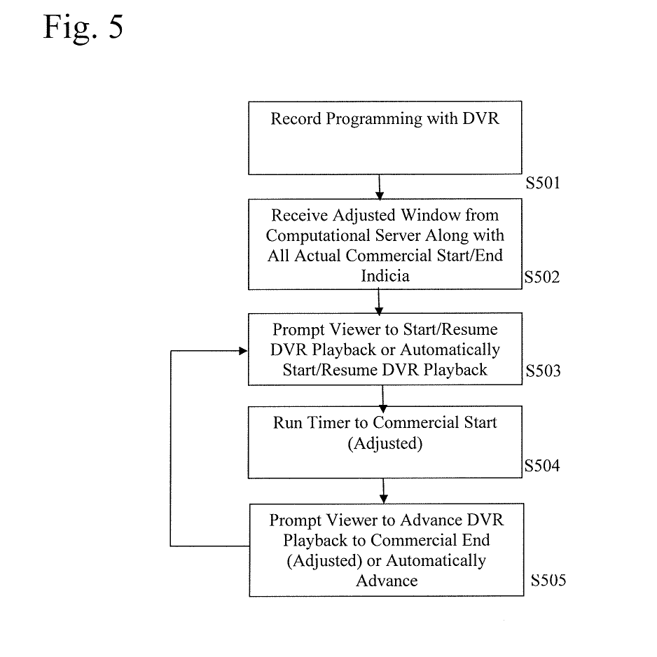

Detection of advertisements, according to exemplary embodiments of the present invention, is not limited to applications in task switching, as described above. Other applications are contemplated within the spirit and scope of the instant invention. For example, exemplary embodiments of the present invention may be applied to the skipping over of commercials recorded on a digital video recorder (DVR) device. FIG. 5 is a flow chart illustrating an operation of a Client Viewing Mechanism in detecting the commercial advertisements of the video programming and applying the detection to the skipping of commercials in a prerecorded television program in accordance with exemplary embodiments of the present invention. It is to be assumed that the Client Voting Mechanisms and the Computational Server function in a manner comparable to what is described above.

First, the viewer would use a DVR to record a television program (Step S501). The Client Viewing Mechanism may be embodied as a separate device from the DVR or the Client Viewing Mechanism may be integrated with DVR functionality. However, in either case, the Client Viewing Mechanism may receive all actual commercial start/end indicia for the recorded show and the Client Viewing Mechanism may optionally receive the adjusted windows as well (Step S502). In this case, the pertinent times do not necessarily need to be padded in accordance with a viewing delay as the viewer is not watching the show in real time, however, the playback of the DVR program and the counting of time of the Client Viewing Mechanism may be synchronized so that the commercial breaks may align. Synchronization may be performed in any number of ways including matching of time stamps, etc. However, according to a simplified example, synchronization is performed by having the Client Viewing Mechanism start the DVR playback, for example, by sending infrared remote control-type signals thereto or the Client Viewing Mechanism may provide the user with a prompt as to when to begin the playback (Step S503). According to another approach, the Client Viewing Mechanism can control the DVR directly to start playback at the desired moment to ensure synchronization, for example, by sending network signals from the Client Viewing Mechanism to the DVR along an HDMI-CEC connection between the two devices. An exemplary configuration for enabling this approach is described in detail below.

The Client Viewing Mechanism may then count time until the commercial break, as calculated from the adjusted window (Step S504). When the time to the commercial break has substantially elapsed and the commercial break is about to begin, a duration of the commercial break is calculated, for example, by subtracting the end time by the begin time, and the Client Viewing Mechanism advances the DVR by the calculated duration (Step S505). Advancement may be performed, for example, by knowing the DVR's ability to skip ahead and behind, e.g. how many seconds ahead a single “skip” provides and how many seconds behind a single “reverse” provides and then determining how many skips or skips and reverses are needed to jump past the commercial as accurately as possible.

For example, if the duration of the commercial break is three minutes and the DVR's skip feature advances 30 seconds, the Client Viewing Mechanism may command six skips. For example, if the duration of the commercial break is two minutes and the DVR's skip feature is 45 seconds and the DVR's reverse feature is 20 seconds, the Client Viewing Mechanism could either command two skips, requiring the viewer to watch 30 seconds of commercial, or the Client Viewing Mechanism can command three skips and one reverse, requiring the viewer to watch only 5 seconds of commercial. Another possibility is for the Client Viewing Mechanism to command 4 skips and 3 reverses, which should place the program right at the end of the commercial break, however, in certain circumstances, skips and reverses may take time and a determination may be made as to whether it is better to get closer to the end of the commercial break using a high number of skip and reverse commands or whether it is better to use a low number of skip and reverse commands and permit the viewer to watch some length of commercials.

The Client Viewing Mechanism, upon determining the desired number of skips and/or reverses, may either prompt the user to manually advance the DVR or the Client Viewing Mechanism may directly control the DVR, for example, by issuing infrared remote control-type commands or by sending network signals from the Client Viewing Mechanism to the DVR along the HDMI-CEC connection between the two devices.

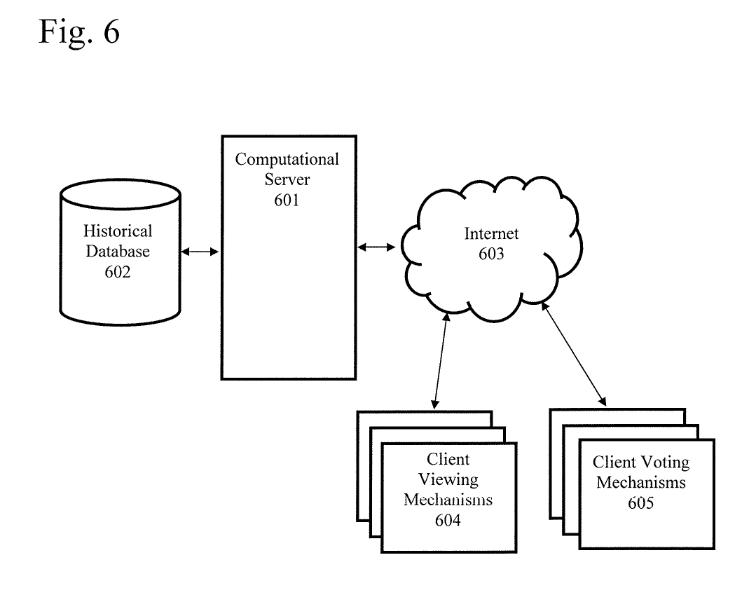

FIG. 6 is a schematic diagram illustrating an arrangement of a system for detecting commercial advertisements in television programming in accordance with exemplary embodiments of the present invention. The Computational Server 601, which may be embodied as a single computer system, a distributed network of computer systems, or one or more virtual machines running on one or more physical computer systems, may maintain a historical database of programs and their commercial break times 602. The Computational Server 601 may be in communication with one or more Client Voting Mechanisms 605, for example, over the Internet 603. Similarly, the Computational Server 601 may be in communication with one or more Client Viewing Mechanisms 604, for example, over the Internet 603.

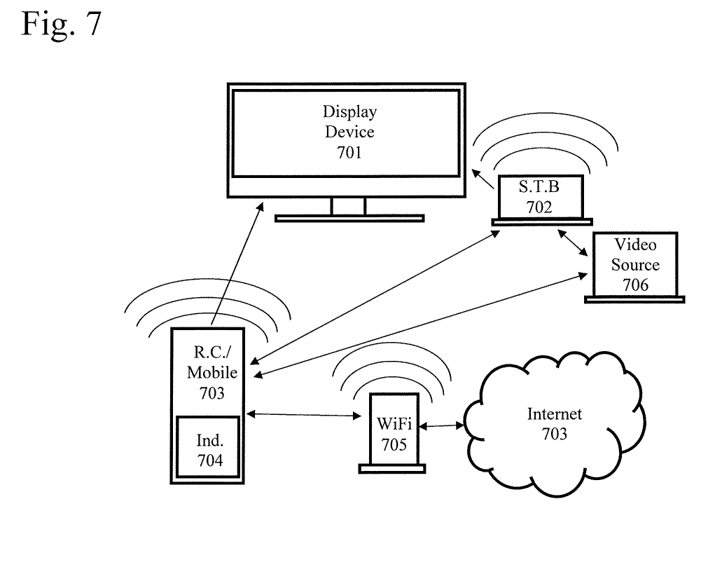

While the Client Voting Mechanisms and the Client Viewing Mechanisms have been described herein as distinct devices, it is to be understood that they may be similar or identical in structure and may vary only in operation. As mentioned above, a single client mechanism may be both a Client Voting Mechanism and a Client Viewing Mechanism. Accordingly, both mechanisms are shown in FIG. 7 and described in detail below using a single exemplary illustration. It is to be understood that the two differing mechanisms may be similar or identical in structure and may differ only in programming or use.

FIG. 7 is a schematic diagram illustrating a Client Voting/Viewing Mechanism for detecting commercials in television programming in accordance with exemplary embodiments of the present invention. A display device 701 may be provided. As discussed above, the display device 701 may be a television set, a computer monitor, a personal computer, tablet computer, smartphone, etc. A set-top-box (STB) 702 may also be provided. The STB 702 may be embodied as a programmable or custom-built device that displays video content to a television set. Examples include ANDROID TV, a set-top-box provided by Google Inc., RASPBERRY PI, a single-board computer system provided by the Raspberry Pi Foundation, and the like. The STB 702 may be responsible for interacting with the Computational Server, for example, over WiFi, displaying video and/or alternative content to the display device 701, and sending/receiving communications from the user. However, according to other exemplary embodiments of the present invention, some or all of these functions may be performed within the display device 701, which may be a Smart TV capable of running computer applications. A cable box, TV tuner, DVR, or other device (referred to as a “Video Source” 706) may be used to provide television programming to the display device 701, either via the STB 702 or directly. Where the Video Source 706 provides television programming via the STB 702, the Video Source 706 may be connected to the STB 702 via an HDMI-CEC cable so that the STB 702 may act as a pass-through for the video content provided by the Video Source 706 and so the STB 702 may control the Video Source 706, for example, to change channels, start, stop and advance DVR playback, or the like. Additionally, because the Video Source 706 passes its video content through the STB 702, the STB may display or superimpose an electronic program guide (EPG) or commercial break countdown clock onto the video signal of the Video Source 706 and may replace or superimpose the alternative task over the video signal.

The STB 702 may include a means of connecting to the Internet 703, for example, by including a WiFi radio which is in communication with a WiFi router 705. Where the display device 701 is a Smart TV, it may include the WiFi radio. A connection by Ethernet cable or other means is also contemplated.

The user may interact with the STB 702 via a hand-held unit 703. The hand-held unit may be embodied as either a remote control device or a smartphone/personal computer/tablet etc. that is capable of executing a custom application or executing a web browser that can connect to the STB 702.

According to one exemplary embodiment of the present invention, the hand-held unit 703 may include the entire logic of the Client Voting/Viewing Mechanism and the STB 702 may be a more simple device such as a CHROMECAST digital media player, provided by Google Inc., which is under the control of the hand-held unit 703 and merely displays the content as determined by the hand-held unit 703.

However, for the purposes of providing a simplified explanation, the STB 702 is described herein as providing the logic of the Client Voting/Viewing Mechanism. The STB 702 may also be configured to control the Display Device 701 or the cable box/DVR (not shown), for example, by infrared remote control-type signals, Bluetooth, WiFi, etc.

As described above, hand-held unit 703 may be a remote control unit or it may be a mobile device such as a smartphone running the Android operating system provided by Google Inc. and the Open Handset Alliance or a smartphone running the iOS operating system provided by Apple Inc. The hand-held unit 703 may communicate with the STB 702, for example, via the WiFi router 705 and/or by infrared remote control-type signals. The hand-held unit 703 may similarly communicate with the STB 702, for example, via the WiFi router 705 and/or by infrared remote control-type signals. The hand-held unit 703 may also control the display device 701, for example, via infrared remote control-type signals.

Where the hand-held unit 703 is a smartphone/personal computer/tablet computer, etc. the hand-held unit 703 may execute a custom application designed for controlling and/or operating as the Client Voting/Viewing Mechanism. The hand-held unit 703 may also include an indicator informing the user of an imminent switch in commercial break status and/or a user interface for the user to generate the indicia of commercial break begin/end. The hand-held unit 703 may also be used to change programming on the display device 701, modify the viewer padding value, and perform one or more of the functions described above.

According to one exemplary embodiment of the present invention, the Client Voting/Viewing Mechanism, and in particular, the Client Voting Mechanism, may include only a single computer system running a custom application with one or more television programming networks being simultaneously displayed on a single screen so that the voter may monitor multiple program feeds and provide the above-described indicia. The displayed user alerts counting down time to the next estimated commercial break status change may help the voter direct attention to a particular program from the multiple programming networks being simultaneously displayed. Each displayed programming network may have its own set of notifications and controls. In this way a single voter can simultaneously provide indicia information for multiple programming networks.

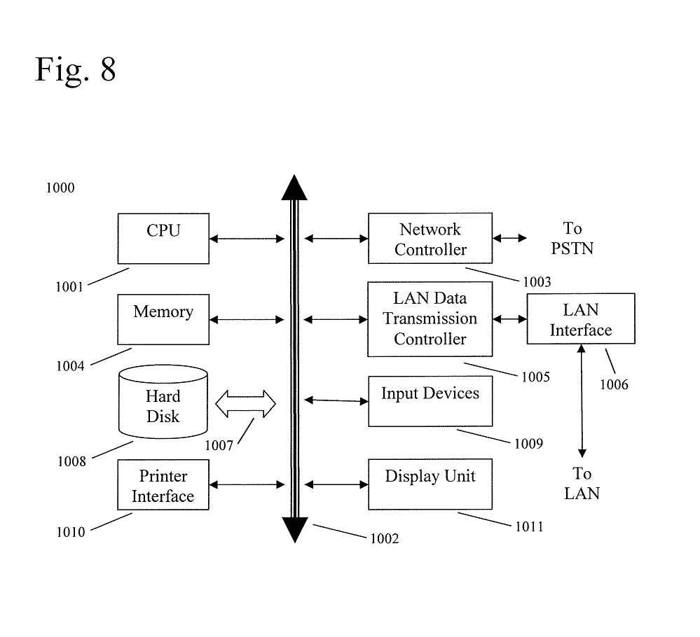

FIG. 8 shows an example of a computer system which may implement a method and system of the present disclosure, for example, as the Computational Server, the display device, the set-top-box, and/or the hand-held unit. The system and method of the present disclosure may be implemented in the form of a software application running on a computer system, for example, a mainframe, personal computer (PC), handheld computer, server, etc. The software application may be stored on a recording media locally accessible by the computer system and accessible via a hard wired or wireless connection to a network, for example, a local area network, or the Internet.

The computer system referred to generally as system 1000 may include, for example, a central processing unit (CPU) 1001, random access memory (RAM) 1004, a printer interface 1010, a display unit 1011, a local area network (LAN) data transmission controller 1005, a LAN interface 1006, a network controller 1003, an internal bus 1002, and one or more input devices 1009, for example, a keyboard, mouse etc. As shown, the system 1000 may be connected to a data storage device, for example, a hard disk, 1008 via a link 1007.

Exemplary embodiments described herein are illustrative, and many variations can be introduced without departing from the spirit of the disclosure or from the scope of the appended claims. For example, elements and/or features of different exemplary embodiments may be combined with each other and/or substituted for each other within the scope of this disclosure and appended claims.

What is claimed is:

1. A method for detecting a commercial advertisement in a video program, comprising:
estimating a timing of a commercial advertisement within the video program based on historical timing of a plurality of previous commercial advertisements within the video program;
displaying the video program on a first display device;
displaying a first alert on a client voting mechanism associated with the first display device, when the estimated timing of the commercial advertisement indicates that a beginning of the commercial advertisement is imminent;
receiving, from the viewer of the first display device, an indication that the commercial advertisement has begun, using the client voting mechanism;
sending the indication of the beginning of the commercial advertisement from the client voting mechanism to a client viewing mechanism associated with a second display device; and
switching a display of the second display device from the video program to an alternative task when the indication of the beginning of the commercial advertisement is received.

2. The method of claim 1, further comprising:
displaying a second alert on the client voting mechanism when the estimated timing of the commercial advertisement indicates that an ending of the commercial advertisement is imminent;
receiving, from the viewer of the first display device, an indication that the commercial advertisement has ended, using the client voting mechanism;
sending the indication of the ending of the commercial advertisement from the client voting mechanism to the client viewing mechanism; and
switching the display of the second display device from the alternative task to the video programming when the indication of the ending of the commercial advertisement is received.

3. The method of claim 1, wherein the first alert on the client voting mechanism is a countdown alert beginning at a fixed time before the estimated beginning of the commercial advertisement and ending at the estimated beginning of the commercial advertisement.

4. The method of claim 1, wherein the sending of the indication of the beginning of the commercial advertisement from the client voting mechanism to the client viewing mechanism is performed over the Internet, with a computational server acting as an intermediary to the sending.

5. The method of claim 4, wherein there are a plurality of client voting mechanisms and the alert is sent from the computational server to the client viewing mechanism based on a plurality of alerts received by the plurality of client voting mechanisms.

6. The method of claim 1, wherein the alternative task is an execution of a computer application.

7. The method of claim 1, wherein switching the display of the second display device includes changing the display of the second display device from exclusively displaying the video program to exclusively displaying the alternative task.

8. The method of claim 1, wherein switching the display of the second display device includes changing from a first display configuration in which the second display device displays the video program with a primary focus while the second display device simultaneously displays the alternative task with a secondary focus to a second display configuration in which the second display device displays the alternative task with the primary focus while the second display device simultaneously displays the video program with the secondary focus.

9. The method of claim 1, wherein a padding value, representing a length of a delay in the displaying of the video program on the second display device, is stored by the client viewing mechanism and the switching of the display of the second display device from the video program to the alternative task is delayed by the padding value after the indication of the beginning of the commercial advertisement is received.

10. The method of claim 9, wherein the padding value is set according to a video program service provider of the second display device and a viewer of the second display device modifies the padding value as desired.

11. The method of claim 1, wherein an electronic program guide, indicating a plurality of television networks and video programming available for each of the plurality of networks at a plurality of different time slots, is provided to the client viewing mechanism and the electronic program guide is updated, in real-time, to reflect a status of each of the plurality of television networks, as either presently in commercial or presently in video program, based on the received indication that the commercial advertisement has begun.

12. A system for detecting a commercial advertisement in a video program, comprising:
a computational server configured to retrieve historical timing of a plurality of previous commercial advertisements within the video program from a historical database and to estimate a timing of the commercial advertisement within the video program based on the retrieved historical timing;
a first display device configured to display the video program;
a client voting mechanism, associated with the first display device, configured to display an alert when the estimated timing of the commercial advertisement indicates that a beginning of the commercial advertisement is imminent, to receive, from a viewer of the first display device, an indication that the commercial advertisement has begun, and transmit the indication of the beginning of the commercial advertisement to a client viewing mechanism associated with a second display device; and
the client viewing mechanism configured to switch a display of the second display device from the video program to an alternative task when the indication of the beginning of the commercial advertisement is received.

13. The system of claim 12, wherein the client viewing mechanism includes a set-top-box for providing the alternative task to the second display device.

14. The system of claim 12, wherein the client voting mechanism includes a hand held unit for receiving, from the viewer of the first display device, the indication of the beginning of the commercial advertisement.

15. A method for playing a recorded video program, comprising:
estimating a timing of a commercial advertisement within a video program based on historical timing of the commercial advertisement within the video program;
recording the video program using a digital video recorder (DVR) and simultaneously displaying the video program on a first display device;
displaying a first alert on a client voting mechanism associated with the first display device, when the estimated timing of the commercial advertisement indicates that a beginning of the commercial advertisement is imminent;
receiving, from the viewer of the first display device, an indication that the commercial advertisement has begun, using the client voting mechanism;
receiving, from the viewer of the first display device, an indication that the commercial advertisement has ended, using the client voting mechanism;
playing the recorded video program using the DVR from a start of the recorded program to a point corresponding to a time when the indication of the beginning of the commercial advertisement was received;
calculating a number of advances needed to skip the playing of the commercial advertisement based on the point corresponding to a time when the indication of the beginning of the commercial advertisement was received and a point corresponding to a time when the indication of the ending of the commercial advertisement was received;
advancing the playing of the recorded video program by the calculated number of advances; and
continuing the playing of the recorded video program.

16. The method of claim 15, wherein the first alert on the client voting mechanism is a countdown alert beginning at a fixed time before the estimated beginning of the commercial advertisement and ending at the estimated beginning of the commercial advertisement.

17. The method of claim 15, wherein the receiving of the indication of the beginning of the commercial advertisement by the DVR is performed over the Internet, with a computational server acting as an intermediary to the receiving.

18. The method of claim 17, wherein there are a plurality of client voting mechanisms and the alert is sent from the computational server to the DVR based on a plurality of alerts received by the plurality of client voting mechanisms.

19. The method of claim 15, wherein an electronic program guide, indicating a plurality of television networks and video programming available for each of the plurality of networks at a plurality of different time slots, is provided to the client viewing mechanism and the electronic program guide is updated, in real-time, to reflect a status of each of the plurality of television networks, as either presently in commercial or presently in video program, based on the received indication that the commercial advertisement has begun.
